(19) United States
(12) Patent Application Publication
(10) Pub. No.: US 2024/0403411 A1
(43) Pub. Date: Dec. 5, 2024

(54) Methods For Improving Security In Computing Devices Implementing Control Flow Integrity

(71) Applicant: QUALCOMM Incorporated, San Diego, CA (US)

(72) Inventors: Sundeep KUSHWAHA, Round Rock, TX (US); Arvind KRISHNASWAMY, San Jose, CA (US); Sergei LARIN, Austin, TX (US); Can ACAR, San Diego, CA (US); Tianshuo SU, San Diego, CA (US); Awanish PANDEY, Hyderabad (IN); Richard SENIOR, San Diego, CA (US)

(21) Appl. No.: 18/697,722

(22) PCT Filed: Nov. 17, 2022
(86) PCT No.: PCT/US2022/050308

§ 371 Date: Apr. 1, 2024

(30) Foreign Application Priority Data
Dec. 8, 2021 (IN) 202141056986

(51) Int. Cl. G06F 21/53; G06F 12/14; G06F 21/54

(52) U.S. Cl. CPC G06F 21/53; G06F 12/1441; G06F 21/54

(57) ABSTRACT

Various embodiments include methods and devices for maintaining control flow integrity in computing devices. Embodiments may include identifying indirect function call candidate functions from a source code by a compiler, replacing, by the compiler, an indirect function call from the source code with a call to a wrapper function, and collocating the indirect function call candidate functions in at least one range of addresses of memory by a linker. The wrapper function may be configured to determine whether an address to be passed to the indirect function call is within the at least one range of addresses of memory.

### RELATED APPLICATIONS

This application is a national stage application of PCT Application US2022/050308 entitled “Methods For Improving Security In Computing Devices Implementing Control Flow Integrity” filed Nov. 17, 2022, which claims the benefit of priority from Indian Provisional Application No. 202141056986, filed Dec. 8, 2021, the entire contents of both of which are herein incorporated by reference.

### BACKGROUND

Control flow integrity is implemented in processors and computing devices as a security policy that dictates the execution path that a software must follow. Control of the execution path may be implemented using direct call flows, targeting hard coded information in read-only memory, and indirect call flows, targeting information stored in read-memory, heaps, and stacks. Indirect call flows use configurable memory addresses to branch to the targeted information and are vulnerable to attacks by changing the configurable memory addresses to branch to other information.

### SUMMARY

Various disclosed aspects may include apparatuses and methods performed in a computing device for generating executable code to provide control flow integrity. Various aspects may include identifying indirect function call candidate functions from a source code by a compiler, replacing, by the compiler, an indirect function call from the source code with a call to a wrapper function, and collocating the indirect function call candidate functions in at least one range of addresses of memory by a linker, in which the wrapper function is configured to determine whether an address to be passed to the indirect function call is within the at least one range of addresses of memory.

In some aspects, collocating the indirect function call candidate functions in the at least one range of addresses of memory may include collocating a first set of functions of the indirect function call candidate functions in a first range of addresses of a first memory, and collocating a second set of functions of the indirect function call candidate functions in a second range of addresses of a second memory, in which the wrapper function is configured such that determining whether the address to be passed to the indirect function call is within the at least one range of addresses of memory may include determining whether the address to be passed to the indirect function call is within the at least one of the first range of addresses of the first memory and the second range of addresses of the second memory.

Some aspects may further include calculating a first representation of an address of each of the indirect function call candidate functions, and populating a bloom filter using the representation of the address of each of the indirect function call candidate functions, in which the wrapper function is may further include calculating a representation the address to be passed to the indirect function call, and determining whether the address to be passed to the indirect function call is an address of an indirect function call candidate function by comparing the representation the address to be passed to the indirect function call to the bloom filter.

Some aspects may further include setting a hardware bit associated with an address of a first instruction of each of the indirect function call candidate functions, in which the wrapper function may further include to determine whether the hardware bit is associated with the address to be passed to the indirect function call.

Some aspects may further include setting a hardware bit associated with an address of a first instruction of each of the indirect function call candidate functions and determining whether the hardware bit is associated with the address to be passed to the indirect function call by a processor hardware instruction.

Some aspects may further include identifying an aspect of the indirect function call candidate function from the source code, in which collocating the indirect function call candidate functions in at least one range of addresses of memory may include collocating a first set of functions of the indirect function call candidate functions having a first aspect in a first range of addresses of memory, and collocating a second set of functions of the indirect function call candidate functions having a second aspect in a second range of addresses of memory.

Some aspects may further include generating information of boundaries of the at least one range of addresses of memory, in which the wrapper function is configured to use the information of the boundaries of the at least one range of addresses of memory to determine whether the address to be passed to the indirect function call is within the at least one range of addresses of memory.

Some aspects may further include passing the indirect function call candidate functions by the compiler to the linker.

Further aspects include a computing device having a processing device configured to perform operations of any of the methods summarized above. Further aspects include a computing device having means for performing functions of any of the methods summarized above. Further aspects include a non-transitory processor-readable medium having stored thereon processor-executable instructions configured to cause a processor and other components of a computing device to perform operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block and flow diagram illustrating an example of a corralled control flow integrity (CFI) system for implementing various embodiments.

FIG. 3 is a component block diagram illustrating an example of components for corralled CFI for implementing various embodiments.

FIG. 4 is a component block diagram illustrating an example of components for corralled CFI for implementing various embodiments.

FIG. 5 is a process flow diagram illustrating a method for corralled CFI for implementing various embodiments.

FIG. 6 is a process flow diagram illustrating a method for corralled CFI for implementing various embodiments.

FIG. 7 is a component block and flow diagram illustrating an example of a corralled CFI system using a bloom filter for implementing various embodiments.

FIG. 8 is a component block diagram illustrating an example of components for corralled CFI using a bloom filter for implementing various embodiments.

FIG. 9 is a process flow diagram illustrating a method for corralled CFI using a bloom filter for implementing various embodiments.

FIG. 10 is a component block and flow diagram illustrating an example of a corralled CFI system using a hardware bit for implementing various embodiments.

FIG. 11 is a component block diagram illustrating an example of components for corralled CFI using a hardware bit for implementing various embodiments.

FIG. 12 is a process flow diagram illustrating a method for corralled CFI using a hardware bit for implementing various embodiments.

FIG. 13 is a component block diagram illustrating an example mobile computing device suitable for implementing the various embodiments.

FIG. 14 is a component block diagram illustrating an example mobile computing device suitable for implementing the various embodiments.

FIG. 15 is a component block diagram illustrating an example server suitable for implementing the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices implementing such methods of corralled control flow integrity (CFI). In some embodiments, corralled CFI may include replacing an indirect function call with a wrapper function configured to determine whether the indirect function call is in a valid address range of corralled indirect function call candidate functions. As used herein the term “wrapper function” refers to a function having an instruction configured to determine whether an address to be passed to an indirect function call resides in a range of memory addresses. The indirect function call candidate functions may be corralled, or grouped in memory, in the address range. In some embodiments, the indirect function call candidate functions may be corralled in multiple address ranges of multiple memories, and the wrapper function may be configured to determine whether the indirect function call is in one of the multiple address ranges. In some embodiments, the indirect function call candidate functions may be hashed into a bloom filter configured to indicate whether addresses of indirect function calls are valid, and the wrapper function may be configured to determine whether the indirect function call is for a valid address according to the bloom filter. In some embodiments, the indirect function call candidate functions may have an instruction added to a first instruction to set a hardware bit, and the wrapper function may be configured to determine whether the indirect function call is for a valid address according to a status of the hardware bit.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, supercomputers, mainframe computers, embedded computers (such as in vehicles and other larger systems), servers, multimedia computers, and game consoles.

Various embodiments are described in terms of code, e.g., processor-executable instructions, for ease and clarity of explanation, but may be similarly applicable to any data, e.g., code, program data, or other information stored in memory. The terms “code”, “data”, and “information” are used interchangeably herein and are not intended to limit the scope of the claims and descriptions to the types of code, data, or information used as examples in describing various embodiments.

The term “linker” is used herein to refer to a computer program configured to combine one or more computer files containing executable computer code generated by a compiler into an executable file.

Control flow integrity is implemented in processors and computers as a security policy that dictates the execution path that a software must follow. Control of the execution path may be implemented using indirect call flows, targeting information stored in read-memory, heaps, and stacks. Forward edge CFI for indirect call flows use configurable memory addresses to jump to the targeted information and are vulnerable to attacks that change the configurable memory addresses to jump to other information.

Various embodiments described herein address the security vulnerabilities of forward edge CFI for indirect call flows by confirming whether a memory address for an indirect jump is in a corral, or valid range, of memory addresses for indirect function call candidate functions. A compiler may be configured to identify an indirect function call and the indirect function call candidate functions. The compiler may replace the indirect function call with a call to a wrapper function configured to determine whether an address for the indirect function call is within the corral of memory addresses for the indirect function call candidate functions. The compiler may also provide a linker with the indirect function call candidate functions. The linker may collocate the indirect function call candidate functions in the corral of memory addresses and generate information identifying the corral of memory addresses for use by the wrapper function. In this manner, various embodiments may prevent indirect function calls to unauthorized addresses outside of the corral by checking whether the address for the indirect function call is in the corral of memory addresses.

In some embodiments, the linker may collocate groups of the indirect function call candidate functions in multiple corrals of memory addresses. For example, different corrals may be for indirect function call candidate functions in different memories. The wrapper function may be configured to determine whether the address for the indirect function call is within any of the corrals of memory addresses for the indirect function call candidate functions. In this manner, some embodiments may prevent indirect function calls to unauthorized addresses outside of the corral by checking whether the address for the indirect function call is in one of the multiple corrals of memory addresses.

In some embodiments, the linker may implement a hash function using the addresses of the indirect function call candidate functions to index the addresses of the indirect function call candidate functions into a bloom filter. The bloom filter may be configured to indicate that the addresses of the indirect function call candidate functions are valid addresses in the corral of memory addresses of the indirect function call candidate functions. The wrapper function may be configured to determine whether the address for the indirect function call is within the corral of memory addresses for the indirect function call candidate functions, and whether the address for the indirect function call in the corral is valid. In this manner, some embodiments may prevent indirect function calls to unauthorized addresses outside of the corral and indirect function calls to addresses in the corral other than the beginning of the indirect function call candidate functions by checking whether the address for the indirect function call is in the corral of memory addresses and whether the address for the indirect function call in the corral is valid.

In some embodiments, the linker may set a hardware bit associated with a memory address for a first instruction of each of the indirect function call candidate functions. The wrapper function may be configured to determine whether the address for the indirect function call is within the corral of memory addresses for the indirect function call candidate functions, and whether the address for the indirect function call is for the first instruction of the indirect function call by determining whether the hardware bit is set for the address for the indirect function call. In this manner, some embodiments may prevent indirect function calls to unauthorized addresses outside of the corral and indirect function calls to addresses in the corral other than the beginning of the indirect function call candidate functions by checking whether the address for the indirect function call is in the corral of memory addresses and whether the address for the indirect function call is for the first instruction of the indirect function call.

In some embodiments, the linker may set a hardware bit associated with a memory address for a first instruction of each of the indirect function call candidate functions. A processor hardware may be configured such that when an indirect call is made, the processor checks whether the hardware bit is set. In this manner, some embodiments may prevent indirect function calls to unauthorized addresses outside of the corral and indirect function calls to addresses in the corral other than the beginning of the indirect function call candidate functions by checking whether the address for the indirect function call is in the corral of memory addresses and whether the address for the indirect function call is for the first instruction of the indirect function call.

Various embodiments improve the security and functioning of processors and computing devices by preventing security vulnerabilities of forward edge CFI that could otherwise be exploited in attacks that attempt to change the configurable memory addresses to jump to other information.

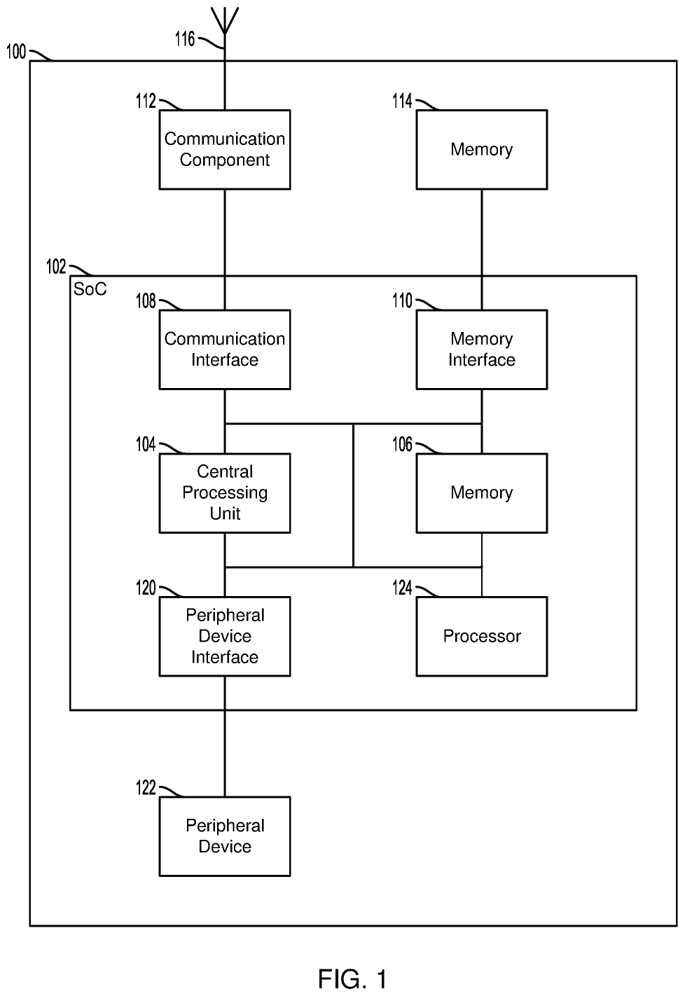

FIG. 1 illustrates a system including a computing device 100 suitable for use with various embodiments. The computing device 100 may include an SoC 102 with a central processing unit 104, a memory 106, a communication interface 108, a memory interface 110, a peripheral device interface 120, and a processing device 124. The computing device 100 may further include a communication component 112, such as a wired or wireless modem, a memory 114, an antenna 116 for establishing a wireless communication link, and/or a peripheral device 122. The processor 124 may include any of a variety of processing devices, such as processors including a plurality of processor cores.

The term “system-on-chip” or “SoC” is used herein to refer to a set of interconnected electronic circuits typically, but not exclusively, including a processing device, a memory, and a communication interface. A processing device may include a variety of different types of processors 124 and/or processor cores, such as a general purpose processor, a central processing unit (CPU) 104, a digital signal processor (DSP), a graphics processing unit (GPU), an accelerated processing unit (APU), a secure processing unit (SPU), an intellectual property unit (IPU), a subsystem processor of specific components of the computing device, such as an image processor for a camera subsystem or a display processor for a display, an auxiliary processor, a peripheral device processor, a single-core processor, a multicore processor, a controller, and/or a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and/or time references. Integrated circuits may be configured such that the components of the integrated circuit reside on a single piece of semiconductor material, such as silicon.

An SoC 102 may include one or more CPUs 104 and processors 124. The computing device 100 may include more than one SoC 102, thereby increasing the number of CPUs 104, processors 124, and processor cores. The computing device 100 may also include CPUs 104 and processors 124 that are not associated with an SoC 102. Individual CPUs 104 and processors 124 may be multicore processors. The CPUs 104 and processors 124 may each be configured for specific purposes that may be the same as or different from other CPUs 104 and processors 124 of the computing device 100. One or more of the CPUs 104, processors 124, and processor cores of the same or different configurations may be grouped together. A group of CPUs 104, processors 124, or processor cores may be referred to as a multi-processor cluster.

The memory 106 of the SoC 102 may be a volatile or non-volatile memory configured for storing data and processor-executable code for access by the CPU 104, the processor 124, or other components of SoC 102. The computing device 100 and/or SoC 102 may include one or more memories 106 configured for various purposes. One or more memories 106 may include volatile memories such as random-access memory (RAM), including DDR, implemented as main memory or cache memory. These memories 106 may be configured to temporarily hold a limited amount of data received from a data sensor or subsystem, data and/or processor-executable code instructions that are requested from non-volatile memory, loaded to the memories 106 from non-volatile memory in anticipation of future access based on a variety of factors, and/or intermediary processing data and/or processor-executable code instructions produced by the CPU 104 and/or processor 124 and temporarily stored for future quick access without being stored in non-volatile memory. The memory 106 may be configured to store data and processor-executable code, at least temporarily, that is loaded to the memory 106 from another memory device, such as another memory 106 or memory 114, for access by one or more of the CPU 104, the processor 124, or other components of SoC 102. In some embodiments, any number and combination of memories 106 may include one-time programmable or read-only memory.

The memory interface 110 and the memory 114 may work in unison to allow the computing device 100 to store data and processor-executable code on a volatile and/or non-volatile storage medium, and retrieve data and processor-executable code from the volatile and/or non-volatile storage medium. The memory 114 may be configured much like an embodiment of the memory 106, such as main memory, in which the memory 114 may store the data or processor-executable code for access by one or more of the CPU 104, the processor 124, or other components of SoC 102. In some embodiments, the memory 114, being non-volatile, may retain the information after the power of the computing device 100 has been shut off. When the power is turned back on and the computing device 100 reboots, the information stored on the memory 114 may be available to the computing device 100. In some embodiments, the memory 114, being volatile, may not retain the information after the power of the computing device 100 has been shut off. The memory interface 110 may control access to the memory 114 and allow the CPU 104, the processor 124, or other components of the SoC 102 to read data from and write data to the memory 114.

Some or all of the components of the computing device 100 and/or the SoC 102 may be arranged differently and/or combined while still serving the functions of the various embodiments. The computing device 100 may not be limited to one of each of the components, and multiple instances of each component may be included in various configurations of the computing device 100.

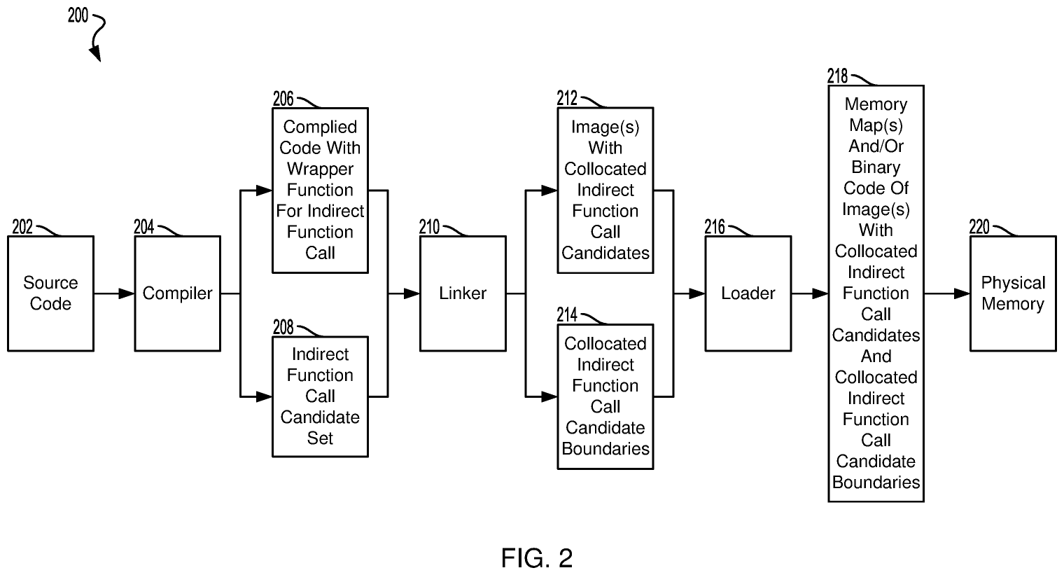

FIG. 2 illustrates an example of a corralled control flow integrity (CFI) system 200 flow suitable for implementing various embodiments. With reference to FIGS. 1 and 2, the corralled CFI system 200 may be implemented on a computing device (e.g., computing device 100 in FIG. 1) by a processor (e.g., CPU 104, processor 124 in FIG. 1) executing a compiler 204 and a linker 210. In some embodiments, the corralled CFI system 200 may be implemented executing a loader 216 and with a physical memory 220 (e.g., memory 106, 114 in FIG. 1).

A source code 202 may be received by the corralled CFI system 200. The compiler 204 may generate a complied code 206 with a call to a wrapper function for an indirect function call and an indirect function call candidate function set 208. The compiler 204 may identify an indirect function call in the source code 202 and any functions that may be called via the indirect function call. For example, a function of the source code 202 may include an instruction to return an address from a data structure, such as a function pointer table, having addresses for potential functions that may be called via an indirect function call. The function of the source code 202 may also include an instruction for the indirect function call using the returned address.

The compiler 204 may identify the potential functions that may be called via the indirect function call from the data structure as the an indirect function call candidate function set 208. The compiler 204 may replace the indirect function call of the source code 202 with a call to the wrapper function in the complied code 206. The wrapper function may be configured to determine whether a memory address of the indirection function call is within a corral, or range of memory addresses, for the indirect function call candidate function set 208, as described further herein. The compiler 204 may provide the complied code 206 with the call to the wrapper function for the indirect function call and the indirect function call candidate function set 208 to the linker 210. In some embodiments, the compiler 204 may further identify aspects of the indirect function call candidate function set 208, such as types of arguments for the functions, numbers of arguments for the functions, etc. The aspects of the indirect function call candidate function set 208 identified by the compiler 204 may be passed to the to the linker 210, for example, as part of the indirect function call candidate function set 208.

The linker 210 may receive the complied code 206 with the call to the wrapper function for the indirect function call and the indirect function call candidate function set 208 from the compiler 204. The linker 210 may generate one or more executable images 212 with collocated indirect function call candidate functions and collocated indirect function call candidate function boundaries 214. An image 212 may include the functions of the compiled code 206, including the wrapper function, and the indirect function call candidate function set 208. The function of the indirect function call candidate function set 208 may be collocated within at least one corral, or range of memory addresses, having addresses corresponding to bounds of the corral. The linker 210 may generate information, such as a file, of the collocated indirect function call candidate function boundaries 214. For example, the linker 210 may use an address of a first instruction of a collocated indirect function call candidate function and an address of a last instruction of another collocated indirect function call candidate function as the collocated indirect function call candidate function boundaries 214. In some embodiments, function of the indirect function call candidate function set 208 may be collocated into multiple corrals based on the aspects of the indirect function call candidate function set 208 identified by the compiler 204. The boundaries may be used by the wrapper function to determine the bounds of the corral of indirect function call candidate functions and whether an address retrieved for an indirect function call is within the corral, as described further herein. The linker 210 may provide the images 212 with collocated indirect function call candidate functions and collocated indirect function call candidate function boundaries 214 to the loader 216.

The loader 216 may receive the images 212 with collocated indirect function call candidate functions and collocated indirect function call candidate function boundaries 214 from the linker 210. The loader 216 may load one or more memory maps and/or binary code of images 218 with collocated indirect function call candidates and collocated indirect function call candidate boundaries to the physical memory 220.

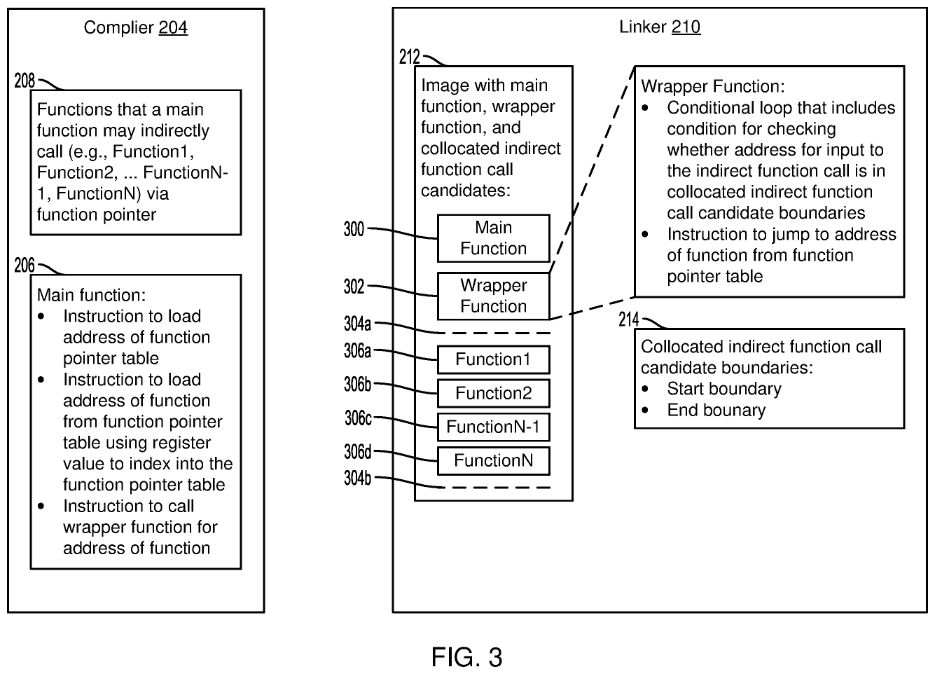

FIG. 3 illustrates components for corralled CFI for implementing various embodiments. With reference to FIGS. 1-3, components of the corralled CFI system (e.g., corralled CFI system 200 in FIG. 2) may be implemented on a computing device (e.g., computing device 100) by a processor (e.g., CPU 104, processor 124 in FIG. 1) executing the compiler 204 and the linker 210.

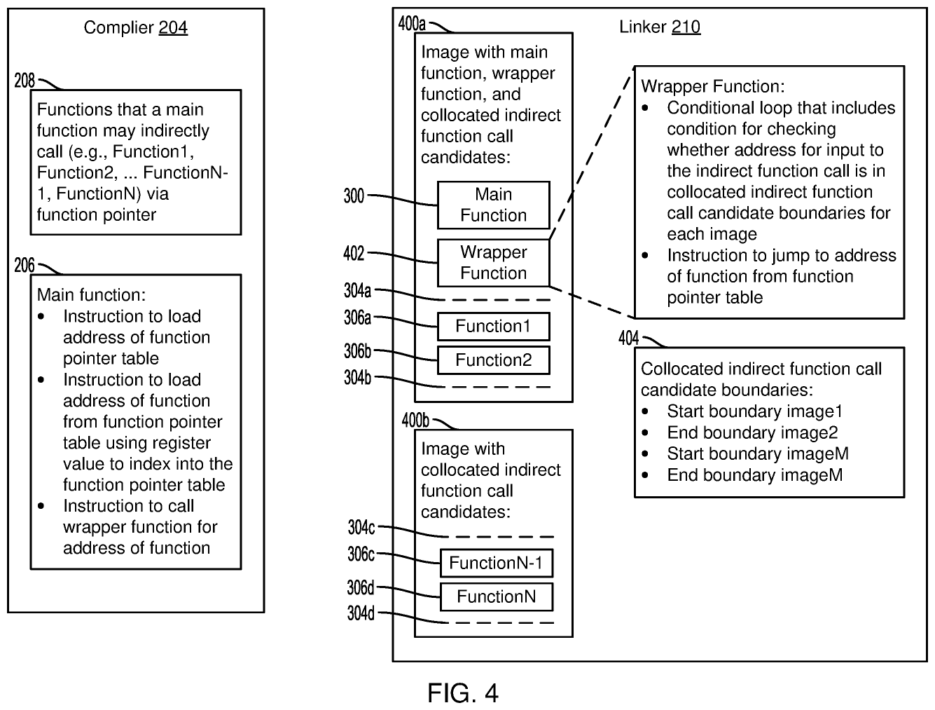

The compiler 204 may compile the source code (e.g., source code 202 in FIG. 2), including compiling a main function 206 of the source code. Compiling the main function 206 may include: compiling an instruction to load addresses of a function pointer table, compiling an instruction to load an address of the function pointer table using the address of the function pointer table and a register value to index into the function pointer table; and replacing the indirection function call with and compiling the instruction to call the wrapper function (e.g., wrapper function 302) using the address loaded from the function pointer table. The compiler 204 may also identify the potential functions that may be called from the main function 206 via the indirect function call from the function pointer table as the indirect function call candidate function set 208. The indirect function call candidate function set 208 may include any number and combination of functions (e.g., Function1, Function2, . . . FunctionN−1, FunctionN in the example illustrated in FIG. 4).

The linker 210 may generate the executable image 212 having the compiled main function 300, the compiled wrapper function 302, and collocated indirect function call candidate functions 306a, 306b, 306c, 306d. The indirect function call candidate functions 306a, 306b, 306c, 306d may be collocated in the image 212 bounded by collocated indirect function call candidate function boundaries 304a, 304b, which may be designated in information, such as a file, of the collocated indirect function call candidate function boundaries 214, including a start boundary and an end boundary.

In an example, the wrapper function 302 may include a conditional loop that includes a condition for checking whether an address for input to the indirect function call is in the collocated indirect function call candidate boundaries 304a, 304b. The collocated indirect function call candidate boundaries 304a, 304b may be retrieved from the information of the collocated indirect function call candidate function boundaries 214. When the address for input to the indirect function call is in the collocated indirect function call candidate boundaries 304a, 304b, the wrapper function 302 may allow implementation of the indirect function call.

FIG. 4 illustrates example components for corralled CFI for implementing various embodiments. With reference to FIGS. 1-4, components of the corralled CFI system (e.g., corralled CFI system 200 in FIG. 2) may be implemented on a computing device (e.g., computing device 100 in FIG. 1) by a processor (e.g., CPU 104, processor 124 in FIG. 1) executing the compiler 204 and the linker 210. The compiler 204 may be implemented and function similarly to the compiler 204 described with reference to FIG. 3.

The linker 210 may generate multiple executable images 400a, 400b (e.g., executable image 212 in FIGS. 2 and 3). The executable images 400a, 400b may be configured for loading to different memories (e.g., memory 106, 114 in FIG. 1, physical memory 220 in FIG. 2), such as a main memory, a tightly coupled memory, etc. An executable image 400a may have the compiled main function 300, the compiled wrapper function 402 (e.g., wrapper function 302 in FIG. 3), and the collocated indirect function call candidate functions 306a, 306b. Another executable image 400b may have the collocated indirect function call candidate functions 306c, 306d. The indirect function call candidate functions 306a, 306b, may be collocated in the image 400a bounded by collocated indirect function call candidate function boundaries 304a, 304b. The indirect function call candidate functions 306c, 306d, may be collocated in the image 400b bounded by collocated indirect function call candidate function boundaries 304c, 304d. The collocated indirect function call candidate function boundaries 304a, 304b, 304c, 304d may be designated in information, such as a file, of the collocated indirect function call candidate function boundaries 404 (e.g., information of the collocated indirect function call candidate function boundaries 214 in FIGS. 2 and 3), including a start boundary and an end boundary for each set of boundaries.

In an example, the wrapper function 402 may include a conditional loop that includes a condition for checking whether an address for input to the indirect function call is in the collocated indirect function call candidate boundaries 304a, 304b, 304c, 304d, for each image 400a, 400b. The collocated indirect function call candidate boundaries 304a, 304b, 304c, 304d may be retrieved from the information of the collocated indirect function call candidate function boundaries 404. When the address for input to the indirect function call is in a set of the collocated indirect function call candidate boundaries, such as boundaries 304a, 304b or boundaries 304c, 304d, the wrapper function 402 may implement the indirect function call by jumping to the address.

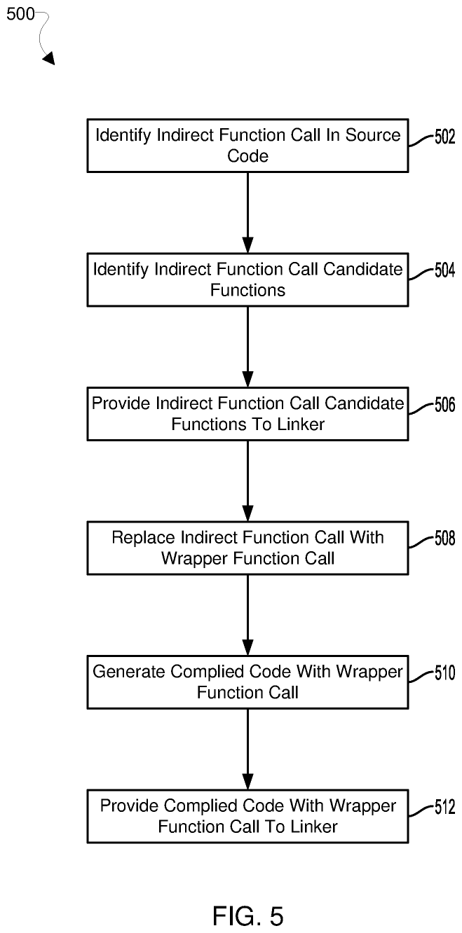

FIG. 5 illustrates a method 500 for corralled CFI according to an embodiment. With reference to FIGS. 1-5, the method 500 may be implemented in a computing device (e.g., computing device 100 in FIG. 1), in hardware (e.g., SoC 102, CPU 104, memory 106, processor 124 in FIG. 1), in software executing in a processor (e.g., compiler 204, linker 210 in FIGS. 2-4), or in a combination of a software-configured processor and dedicated hardware (e.g., corralled CFI system 200 in FIG. 2) that includes other individual components, and various memory/cache controllers. In order to encompass the alternative configurations enabled in various embodiments, the hardware implementing the method 500 is referred to herein as a “processing device.”

In block 502, the processing device may identify an indirect function call in a source code (e.g., source code 202 in FIG. 2). The processing device implementing the compiler (e.g., compiler 204 in FIGS. 2-4) may use know means for identifying the indirect function call. The processing device identifying the indirect function call in the source code in block 502 may be a processor (e.g., CPU 104, processor 124 in FIG. 1).

In block 504, the processing device may identify indirect function call candidate functions (e.g., indirect function call candidate function set 208 in FIGS. 2-4). The processing device implementing the compiler may identify a pointer to a data structure, such as a function pointer table, having addresses for potential functions that may be called via an indirect function call, and parse the address pointers of the functions in the data structure. The processing device identifying the indirect function call candidate functions in block 504 may be the processor.

In block 506, the processing device may provide the indirect function call candidate functions to a linker (e.g., linker 210 in FIGS. 2-4). The processing device implementing the compiler may pass complied data having the address pointers of the functions in the data structure to the linker. The processing device providing the indirect function call candidate functions to the linker in block 506 may be the processor.

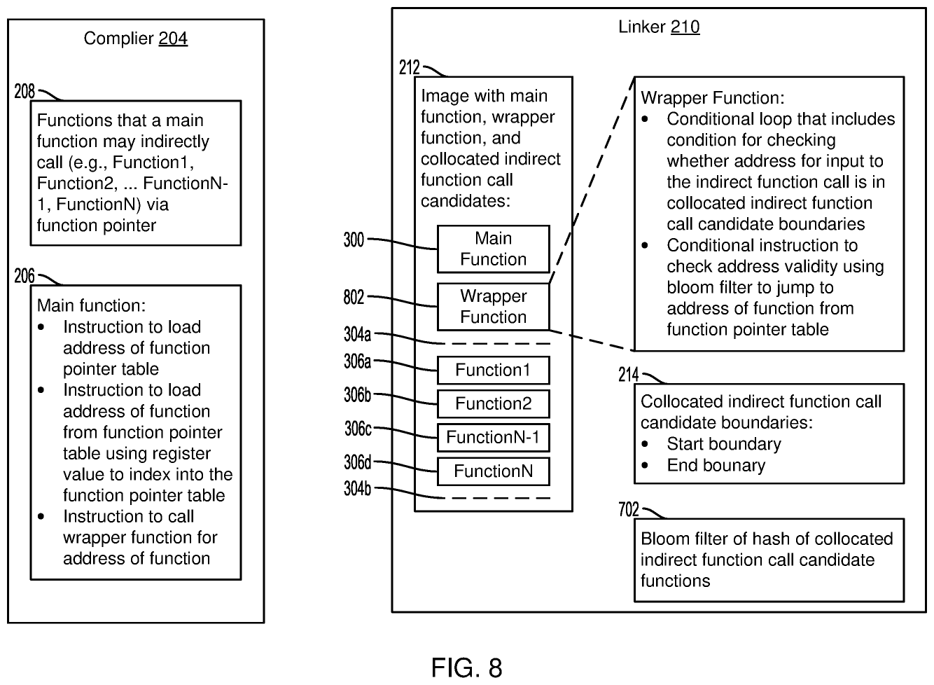

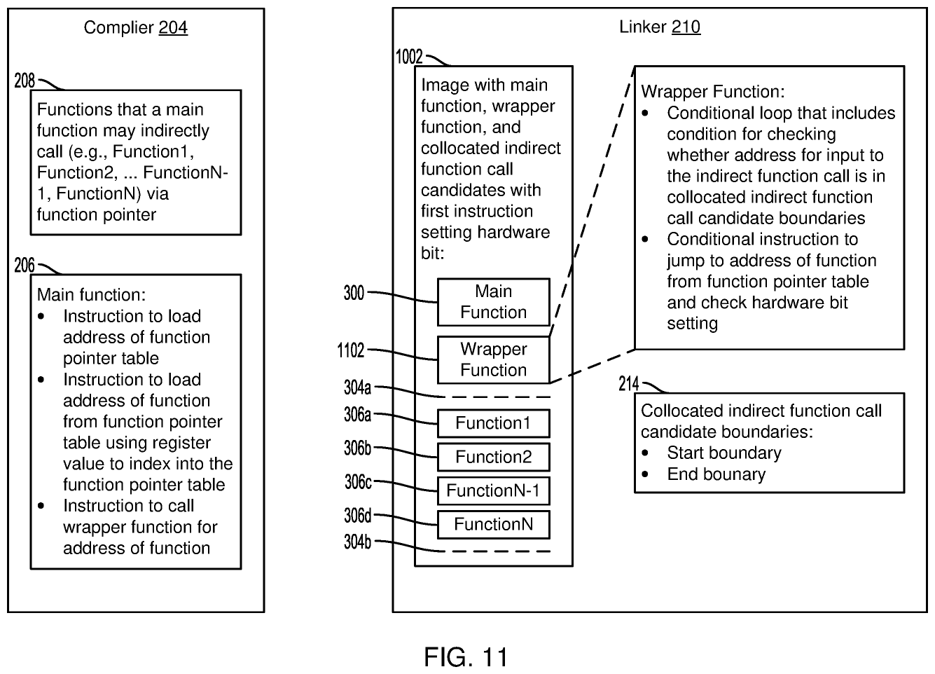

In block 508, the processing device may replace the indirect function call with a call to a wrapper function (e.g., wrapper function 304, 402 in FIGS. 3 and 4). The processing device implementing the compiler, having identified the indirect function call in block 502, may generate a wrapper function configured to determine whether the address to be passed to the indirect function call is within a corral, or range of memory addresses, of at least one corral. The processing device implementing the compiler may then implement the indirect function call for the address in response to determining that the address is within the corral. In some embodiments, the wrapper function may be configured with other functions as described herein for the wrapper function 802, 1102 with reference to FIGS. 8 and 11. The processing device implementing the compiler may replace the indirect function call with a call to the wrapper function in a compiled code (e.g., compiled code 206 in FIGS. 2-4) of the source code. The processing device replacing the indirect function call with the call to the wrapper function in block 508 may be the processor.

In block 510, the processing device may generate the complied code with the wrapper function call (i.e., a call to the wrapper function). The processing device implementing the compiler may compiler the source code using known means and may include the call to the wrapper function in the compiled code. The processing device generating the complied code with the wrapper function call in block 510 may be the processor.

In block 512, the processing device may provide the complied code with the wrapper function call to the linker. The processing device implementing the compiler may pass the complied code having the wrapper function call to the linker. The processing device providing the complied code with the wrapper function call to the linker in block 512 may be the processor.

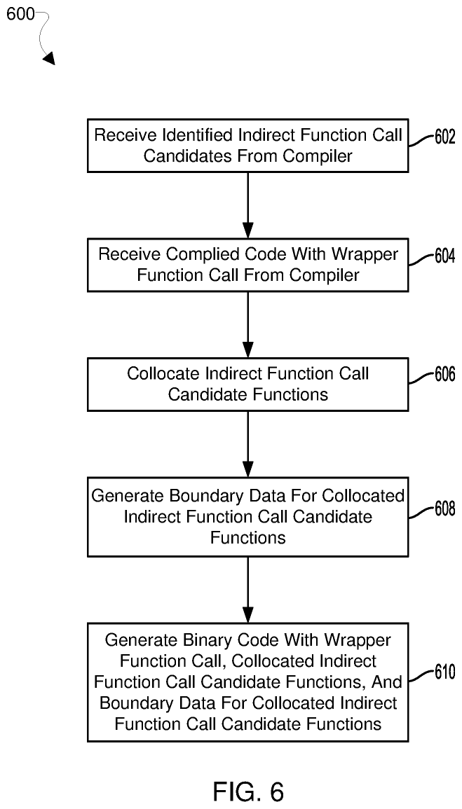

FIG. 6 illustrates a method 600 for corralled CFI according to some embodiments. With reference to FIGS. 1-6, the method 600 may be implemented in a computing device (e.g., computing device 100 in FIG. 1), in hardware (e.g., SoC 102, CPU 104, memory 106, processor 124 in FIG. 1), in software executing in a processor (e.g., compiler 204, linker 210 in FIGS. 2-4), or in a combination of a software-configured processor and dedicated hardware (e.g., corralled CFI system 200 in FIG. 2) that includes other individual components, and various memory/cache controllers. In order to encompass the alternative configurations enabled in various embodiments, the hardware implementing the method 600 is referred to herein as a “processing device.”

In block 602, the processing device may receive the identified indirect function call candidate functions (e.g., indirect function call candidate function set 208 in FIGS. 2-4) from a compiler (e.g., compiler 204 in FIGS. 2-4). The processing device implementing a linker (e.g., linker 210 in FIGS. 2-4) may receive complied data having address pointers of functions in a data structure, such as a function pointer table, having addresses for potential functions that may be called via an indirect function call, passed by the compiler. The processing device receiving the identified indirect function call candidate functions in block 602 may be the processor.

In block 604, the processing device may receive compiled code (e.g., compiled code 206 in FIGS. 2-4) with a wrapper function (e.g., wrapper function 304, 402 in FIGS. 3 and 4) from the compiler. The processing device implementing the linker may receive the complied code having the wrapper function call passed by the compiler. The processing device receiving the compiled code with the wrapper function from the compiler in block 604 may be the processor.

In block 606, the processing device may collocate indirect function call candidate functions (e.g., indirect function call candidate functions 306a, 306b, 306c, 306d in FIGS. 3 and 4) in an executable image (e.g., image 212 in FIGS. 2 and 3, image 400a 400b in FIG. 4). The processing device implementing the linker may group the indirect function call candidate functions in memory such that the indirect function call candidate functions reside within one or more corrals, or ranges of memory addresses, bounded by collocated indirect function call candidate function boundaries (e.g., collocated indirect function call candidate function boundaries 304a, 304b, 304c, 304d in FIGS. 3 and 4). The processing device collocating the indirect function call candidate functions in the executable image in block 606 may be the processor.

In block 608, the processing device may generate information, such as a file, of the collocated indirect function call candidate function boundaries (e.g., information of the collocated indirect function call candidate function boundaries 214, in FIGS. 2 and 3, information of the collocated indirect function call candidate function boundaries 404 in FIG. 4). The processing device implementing the linker may generate information of the collocated indirect function call candidate function boundaries, including a start boundary and an end boundary for each set of boundaries. The processing device generating the information of the collocated indirect function call candidate function boundaries in block 608 may be the processor.

In block 610, the processing device may generate binary code (e.g., binary code of images 218 in FIG. 2) with the wrapper function call, collocated indirect function call candidate functions, and information of the collocated indirect function call candidate function boundaries. The processing device implementing the linker may generate executable binary code from the compiled code modified by the linker to collocate the indirect function call candidate functions in block 606 and from the generated information of the collocated indirect function call candidate function boundaries in block 608. The processing device generating the binary code with the wrapper function call, the collocated indirect function call candidate functions, and the information of the collocated indirect function call candidate function boundaries in block 610 may be the processor.

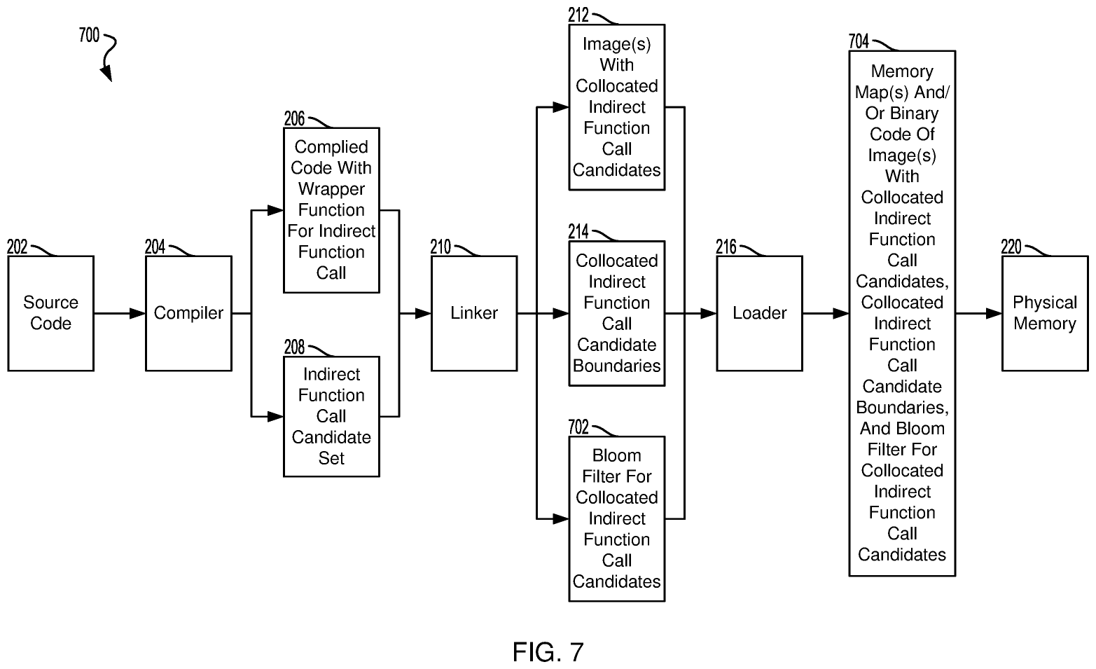

FIG. 7 illustrates an example of a corralled CFI system 700 (e.g., corralled CFI system 200 in FIG. 2) using a bloom filter 702 flow suitable for implementing various embodiments. With reference to FIGS. 1-7, the corralled CFI system 700 may be implemented on a computing device (e.g., computing device 100 in FIG. 1) by a processor (e.g., CPU 104, processor 124 in FIG. 1) executing the compiler 204 and the linker 210. In some embodiments, the corralled CFI system 700 may be implemented executing the loader 216 and with the physical memory 220. Like numbered aspects of the corralled CFI system 700 may be similarly configured as described herein with reference to FIG. 2, including the compiler 204, the linker 210, the loader 216, the physical memory 220, the source code 202, the complied code 206, the indirect function call candidate function set 208, the one or more executable images 212, and collocated indirect function call candidate function boundaries 214.

The CFI system 700 illustrated in FIG. 7 includes the following aspects regarding the corralled CFI system 200 in FIG. 2. The linker 702 may implement an algorithm, such as a hash function, using the addresses of the collocated indirect function call candidate functions of the executable images 212. The results of the algorithm may be used to index the addresses of the collocated indirect function call candidate functions into a bloom filter 702. The bloom filter 702 may include a data structure for which locations in the data structure may include data corresponding to the addresses of the collocated indirect function call candidate functions. A wrapper function included in the images 212 may be further configured to implement the algorithm using the address to be passed to the indirect function call to determine whether the address is a valid address of a collocated indirect function call candidate function, as described further herein. The linker 210 may provide the images 212 with collocated indirect function call candidate functions, collocated indirect function call candidate function boundaries 214, and bloom filter 702 for the addresses of the collocated indirect function call candidate functions to the loader 216.

The loader 216 may receive the images 212 with collocated indirect function call candidate functions, collocated indirect function call candidate function boundaries 214, and bloom filter 702 for the addresses of the collocated indirect function call candidate functions from the linker 210. The loader 216 may load one or more memory maps and/or binary code of images 704 with collocated indirect function call candidates, collocated indirect function call candidate boundaries and the bloom filter for the addresses of the collocated indirect function call candidate functions to the physical memory 220.

FIG. 8 illustrates components for corralled CFI using a bloom filter 702 for implementing various embodiments. With reference to FIGS. 1-8, components of the corralled CFI system (e.g., corralled CFI system 200, 700 in FIGS. 2 and 7) may be implemented on a computing device (e.g., computing device 100 in FIG. 1) by a processor (e.g., CPU 104, processor 124 in FIG. 1) executing the compiler 204 and the linker 210. The compiler 204 may be implemented and function similarly to the compiler 204 as described herein with reference to FIGS. 3 and 4.

The linker 210 may generate at least one executable image 212 (e.g., executable image 212 in FIGS. 2 and 3, executable image 400a, 400b in FIG. 4). The linker 210 may generate the executable image 212 having the compiled main function 300, the compiled wrapper function 302, and the collocated indirect function call candidate functions 306a, 306b, 306c, 306d. The indirect function call candidate functions 306a, 306b, 306c, 306d may be collocated in the image 212 bounded by collocated indirect function call candidate function boundaries 304a, 304b, which may be designated in information, such as a file, of the collocated indirect function call candidate function boundaries 214, including a start boundary and an end boundary. The linker 210 may further generate and/or populate the bloom filter 702 by execution of an algorithm, such as a hash function, using the addresses of the collocated indirect function call candidate functions 306a, 306b, 306c, 306d.

In an example, the wrapper function 802 (e.g., wrapper function 302, 402 in FIGS. 3 and 4) may include a conditional loop that includes a condition for checking whether an address for input to the indirect function call is in the collocated indirect function call candidate boundaries 304a, 304b of at least one collocated indirect function call candidate boundary sets (e.g., collocated indirect function call candidate boundaries 304a, 304b, 304c, 304d in FIGS. 3 and 4). The collocated indirect function call candidate boundaries 304a, 304b may be retrieved from the information of the collocated indirect function call candidate function boundaries 214. When the address for input to the indirect function call is in the collocated indirect function call candidate boundaries 304a, 304b, the wrapper function 802 may implement an algorithm, such as a hash function, using the addresses to be passed to the indirect function call. The algorithm may be the same algorithm as used to generate and/or populate the bloom filter 702. The wrapper function 802 may use the result of the algorithm to compare with the bloom filer 702 to determine whether the address within the corral is a valid address for an indirect function call candidate function 306a, 306b, 306c, 306d. In response to determining that the address within the corral is a valid address for an indirect function call candidate function 306a, 306b, 306c, 306d, the wrapper function 802 may allow implementation of the indirect function call.

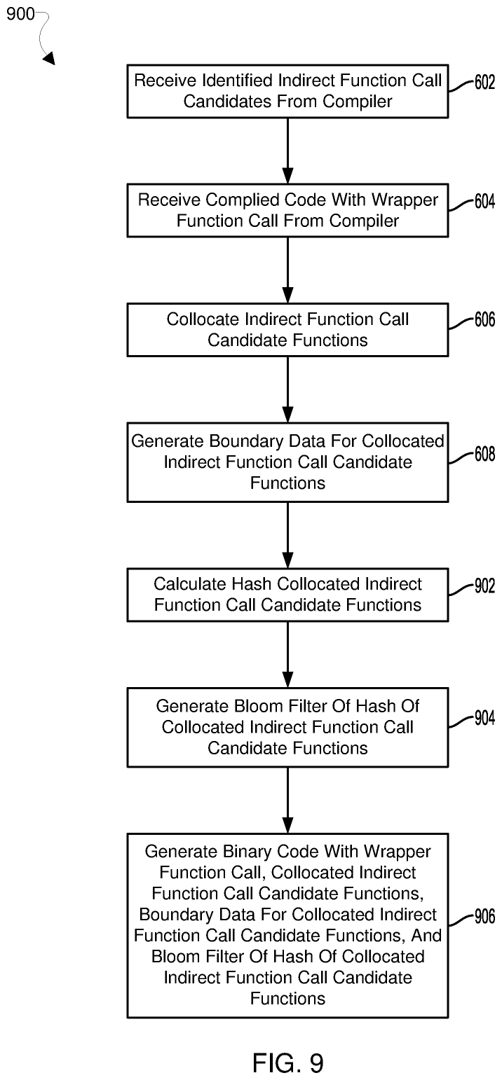

FIG. 9 illustrates a method 900 for corralled CFI using a bloom filter (e.g., a bloom filter 702 in FIGS. 7 and 8) according to an embodiment. With reference to FIGS. 1-6, the method 900 may be implemented in a computing device (e.g., computing device 100 in FIG. 1), in hardware (e.g., SoC 102, CPU 104, memory 106, processor 124 in FIG. 1), in software executing in a processor (e.g., compiler 204, linker 210 in FIGS. 2-4, 7, and 8), or in a combination of a software-configured processor and dedicated hardware (e.g., corralled CFI system 200, 700 in FIGS. 2 and 7) that includes other individual components, and various memory/cache controllers. In order to encompass the alternative configurations enabled in various embodiments, the hardware implementing the method 900 is referred to herein as a “processing device.” Blocks 602, 604, 606, 608 may be implemented in a similar manner as like numbered blocks of the method 600 described herein with reference to FIG. 6.

In block 902, the processing device may calculate an algorithm for the addresses of the collocated indirect function call candidate functions (e.g., collocated indirect function call candidate functions 306a, 306b, 306c, 306d in FIGS. 3, 4, and 8). The processing device implementing the linker (e.g., linker 210 in FIGS. 2-4, 7, and 8) may implement the algorithm, such as a hash function, to generate representations of the addresses that may be used to compare with representations of other addresses calculated using the algorithm to confirm whether the addresses match. The processing device calculating the algorithm for the addresses of the collocated indirect function call candidate functions in block 902 may be a processor (e.g., CPU 104, processor 124 in FIG. 1).

In block 904, the processing device may generate and/or populate a bloom filter of the addresses of the collocated indirect function call candidate functions. The algorithmic representations of the addresses calculated in block 902 may be used to indicate the locations of the data structure of the bloom filter that correlate with the addresses of the collocated indirect function call candidate functions. The processing device implementing the linker may generate and/or populate the bloom filter with the algorithmic representations of the addresses calculated in block 904. The processing device generating and/or populating the bloom filter of the addresses of the collocated indirect function call candidate functions in block 904 may be the processor

In block 906, the processing device may generate binary code (e.g., binary code of images 704 in FIG. 7) with the wrapper function call, collocated indirect function call candidate functions, information of the collocated indirect function call candidate function boundaries, and the bloom filter. The processing device implementing the linker may generate executable binary code from the compiled code modified by the linker to collocate the indirect function call candidate functions in block 606, from the generated information of the collocated indirect function call candidate function boundaries in block 608, and from the bloom filter generated and/or populated in block 904. The processing device generating the binary code with the wrapper function call, the collocated indirect function call candidate functions, the information of the collocated indirect function call candidate function boundaries, and the bloom filter in block 906 may be the processor.

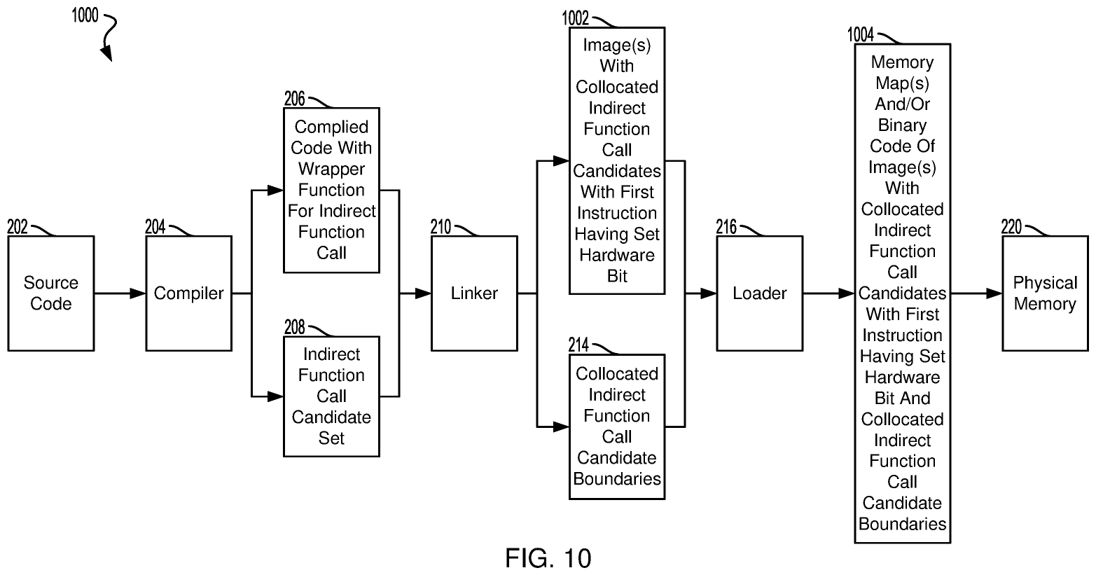

FIG. 10 illustrates an example of a corralled CFI system 1000 (e.g., corralled CFI system 200, 700 in FIGS. 2 and 7) using a hardware bit flow suitable for implementing various embodiments. With reference to FIGS. 1-10, the corralled CFI system 700 may be implemented on a computing device (e.g., computing device 100 in FIG. 1) by a processor (e.g., CPU 104, processor 124 in FIG. 1) executing the compiler 204 and the linker 210. In some embodiments, the corralled CFI system 700 may be implemented executing the loader 216 and with the physical memory 220. Like numbered aspects of the corralled CFI system 1000, such as the compiler 204, the linker 210, the loader 216, the physical memory 220, the source code 202, the complied code 206, the indirect function call candidate function set 208, and collocated indirect function call candidate function boundaries 214 may be similarly configured as described herein with reference to FIGS. 2 and 7.

The CFI system 1000 illustrated in FIG. 10 shows further details regarding the corralled CFI system 200 in FIG. 2. The linker 702 may modify a first instruction of each of the collocated indirect function call candidate functions to have an associated set hardware bit. The value of the associated hardware bit may be configured to indicate to a wrapper function whether the address to be passed to the indirect function call is for the beginning, such as the first instruction, of a collocated indirect function call candidate function. The linker 210 may generate one or more executable images 1004 with collocated indirect function call candidate functions with a first instruction of each function having an associated set hardware bit. An image 1004 may include the functions of the compiled code 206, including the wrapper function, and the indirect function call candidate function set 208.

A wrapper function included in the images 212 may be further configured to implement a check of the value of the hardware bit associated with the address to be passed to the indirect function call to determine whether the address is a valid address of a beginning, such as a first instruction, of a collocated indirect function call candidate function, as described further herein. The linker 210 may provide the images 1002 with collocated indirect function call candidate functions having an associated set hardware bit and the collocated indirect function call candidate function boundaries 214 to the loader 216.

The loader 216 may receive the images 1002 with collocated indirect function call candidate functions having an associated set hardware bit and collocated indirect function call candidate function boundaries 214 from the linker 210. The loader 216 may load one or more memory maps and/or binary code of images 1004 with collocated indirect function call candidate functions having an associated set hardware bit and collocated indirect function call candidate boundaries to the physical memory 220.

FIG. 11 illustrates example components for corralled CFI using a hardware bit for implementing various embodiments. With reference to FIGS. 1-11, components of the corralled CFI system (e.g., corralled CFI system 200, 700, 1000 in FIGS. 2, 7, and 10) may be implemented on a computing device (e.g., computing device 100 in FIG. 1) by a processor (e.g., CPU 104, processor 124 in FIG. 1) executing the compiler 204 and the linker 210. The compiler 204 may be implemented and function similarly to the compiler 204 as described herein with reference to FIGS. 3 and 4.

The linker 210 may generate at least one executable image 1002, such as executable image 212 in FIGS. 2 and 3, executable image 400a, 400b in FIG. 4, executable image 1002 in FIG. 10. The linker 210 may generate the executable image 1002 having the compiled main function 300, the compiled wrapper function 302, and the collocated indirect function call candidate functions 306a, 306b, 306c, 306d. The indirect function call candidate functions 306a, 306b, 306c, 306d may be collocated in the image 1002 bounded by collocated indirect function call candidate function boundaries 304a, 304b, which may be designated in information, such as a file, of the collocated indirect function call candidate function boundaries 214, including a start boundary and an end boundary. The linker 210 may further set a hardware bit associated with each of the first instructions of the indirect function call candidate functions 306a, 306b, 306c, 306d.

In an example, the wrapper function 1102 (e.g., wrapper function 302, 402, 802 in FIGS. 3, 4, and 8) may include a conditional loop that includes a condition for checking whether an address for input to the indirect function call is in the collocated indirect function call candidate boundaries 304a, 304b of at least one collocated indirect function call candidate boundary sets (e.g., collocated indirect function call candidate boundaries 304a, 304b, 304c, 304d in FIGS. 3, 4, and 8). The collocated indirect function call candidate boundaries 304a, 304b may be retrieved from the information of the collocated indirect function call candidate function boundaries 214. When the address for input to the indirect function call is in the collocated indirect function call candidate boundaries 304a, 304b, the wrapper function 1102 may implement an instruction configured to jump to the address to be passed to the indirect function call and determine whether a hardware bit associated with the address is set to a designated value. In response to the hardware bit being set to the designated value the wrapper function 1102 may allow implementation of the function at the address.

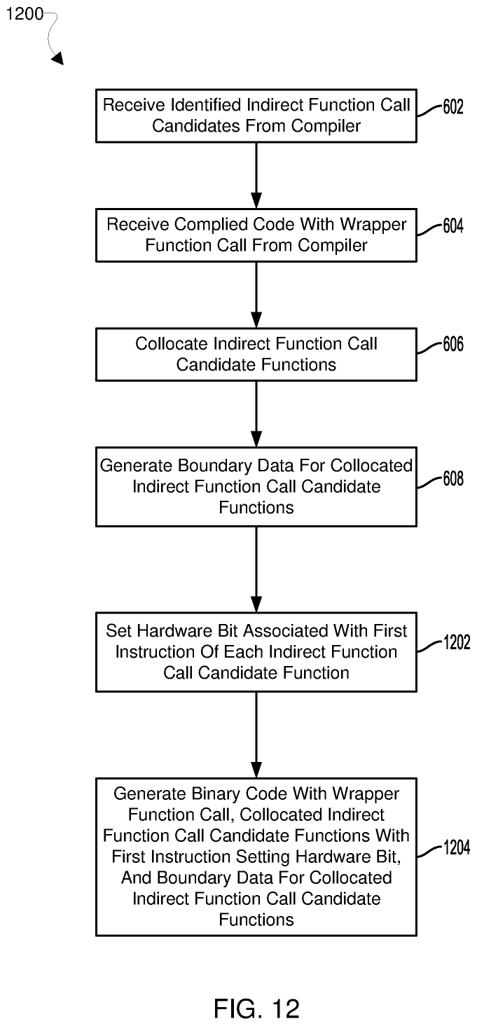

FIG. 12 illustrates a method 1200 for corralled CFI using a hardware bit according to an embodiment. With reference to FIGS. 1-12, the method 1200 may be implemented in a computing device (e.g., computing device 100 in FIG. 1), in hardware (e.g., SoC 102, CPU 104, memory 106, processor 124 in FIG. 1), in software executing in a processor (e.g., compiler 204, linker 210 in FIGS. 2-4, 7, 8, 10, and 11), or in a combination of a software-configured processor and dedicated hardware (e.g., corralled CFI system 200, 700, 1000 in FIGS. 2, 7, 1000) that includes other individual components, and various memory/cache controllers. In order to encompass the alternative configurations enabled in various embodiments, the hardware implementing the method 600 is referred to herein as a “processing device.” Operations in blocks 602, 604, 606, 608 may be implemented in a similar manner as like numbered blocks of the method 600 as described herein with reference to FIG. 6.

In block 1202, the processing device may set a hardware bit associated with a first instruction of each indirect function call candidate function (e.g., indirect function call candidate functions 306a, 306b, 306c, 306d in FIGS. 3, 4, 7, and 10). The processing device implementing the linker (e.g., linker 210 in FIGS. 2-4, 7, 8, 10, and 11) may use the addresses of each indirect function call candidate function to identify the location of a first instruction of each indirect function call candidate function. For each indirect function call candidate function, the processing device may set a hardware bit associated with the address of the first instruction to a designated value configured to indicate that the address is for the first instruction. The processing device setting the hardware bit associated with the first instruction of each indirect function call candidate function in block 1202 may be a processor (e.g., CPU 104, processor 124 in FIG. 1).

In block 1204, the processing device may generate binary code (e.g., binary code of images 1004 in FIG. 10) with the wrapper function call, collocated indirect function call candidates functions having the associated set hardware bit, and information of the collocated indirect function call candidate function boundaries. The processing device implementing the linker may generate executable binary code from the compiled code modified by the linker to collocate the indirect function call candidate functions in block 606 and from the generated information of the collocated indirect function call candidate function boundaries in block 608. The processing device generating the binary code with the wrapper function call, the collocated indirect function call candidate functions having the associated set hardware bit, and the information of the collocated indirect function call candidate function boundaries, in block 1204 may be the processor.

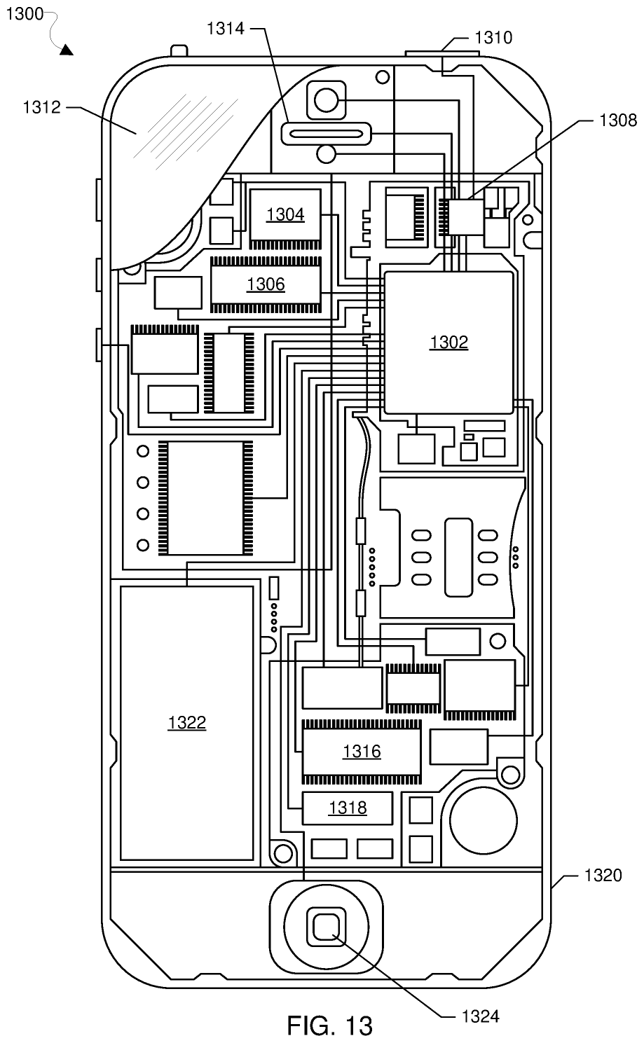

A system in accordance with the various embodiments (including, but not limited to, embodiments described above with reference to FIGS. 1-12) may be implemented in a wide variety of computing systems including mobile computing devices, an example of which is suitable for use with the various embodiments is illustrated in FIG. 13. The mobile computing device 1300 may include a processor 1302 coupled to a touchscreen controller 1304 and an internal memory 1306. The processor 1302 may be one or more multicore integrated circuits designated for general or specific processing tasks. The internal memory 1306 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1304 and the processor 1302 may also be coupled to a touchscreen panel 1312, such as a resistive-sensing touchscreen, capacitive-sensing touchscreen, infrared sensing touchscreen, etc. Additionally, the display of the mobile computing device 1300 need not have touch screen capability.

The mobile computing device 1300 may have one or more radio signal transceivers 1308 (e.g., Peanut, Bluetooth, ZigBee, Wi-Fi, RF radio) and antennae 1310, for sending and receiving communications, coupled to each other and/or to the processor 1302. The transceivers 1308 and antennae 1310 may be used with the above-mentioned circuitry to implement the various wireless transmission protocol stacks and interfaces. The mobile computing device 1300 may include a cellular network wireless modem chip 1316 that enables communication via a cellular network and is coupled to the processor.

The mobile computing device 1300 may include a peripheral device connection interface 1318 coupled to the processor 1302. The peripheral device connection interface 1318 may be singularly configured to accept one type of connection, or may be configured to accept various types of physical and communication connections, common or proprietary, such as Universal Serial Bus (USB), FireWire, Thunderbolt, or PCIe. The peripheral device connection interface 1318 may also be coupled to a similarly configured peripheral device connection port (not shown).

The mobile computing device 1300 may also include speakers 1314 for providing audio outputs. The mobile computing device 1300 may also include a housing 1320, constructed of a plastic, metal, or a combination of materials, for containing all or some of the components described herein. The mobile computing device 1300 may include a power source 1322 coupled to the processor 1302, such as a disposable or rechargeable battery. The rechargeable battery may also be coupled to the peripheral device connection port to receive a charging current from a source external to the mobile computing device 1300. The mobile computing device 1300 may also include a physical button 1324 for receiving user inputs. The mobile computing device 1300 may also include a power button 1324 for turning the mobile computing device 1300 on and off.

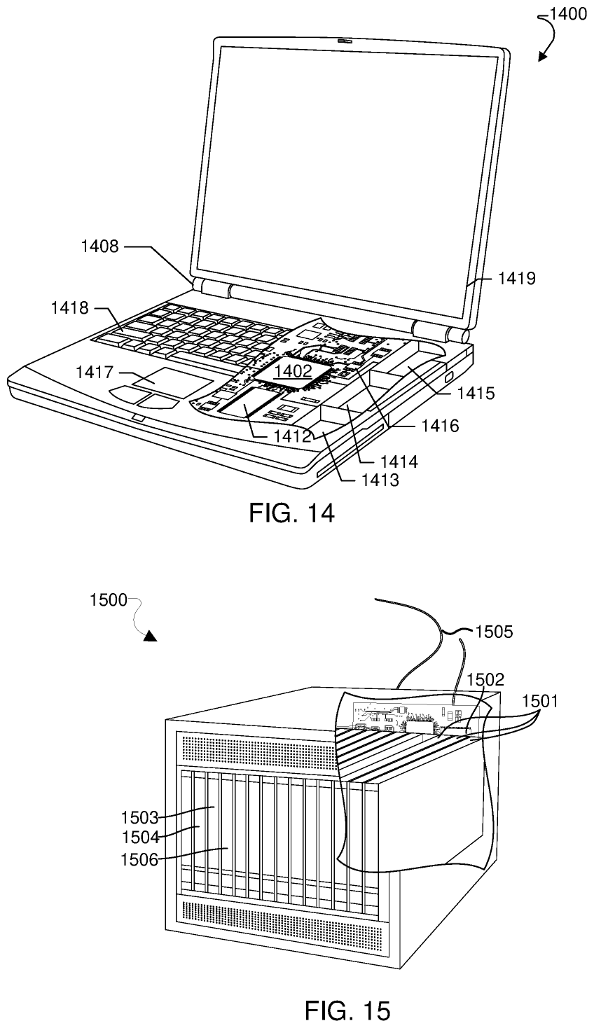

A system in accordance with the various embodiments (including, but not limited to, embodiments described above with reference to FIGS. 1-12) may be implemented in a wide variety of computing systems include a laptop computer 1400 an example of which is illustrated in FIG. 14. Many laptop computers include a touchpad touch surface 1417 that serves as the computer's pointing device, and thus may receive drag, scroll, and flick gestures similar to those implemented on computing devices equipped with a touch screen display and described above. A laptop computer 1400 will typically include a processor 1402 coupled to volatile memory 1412 and a large capacity nonvolatile memory, such as a disk drive 1413 of Flash memory. Additionally, the computer 1400 may have one or more antenna 1408 for sending and receiving electromagnetic radiation that may be connected to a wireless data link and/or cellular telephone transceiver 1416 coupled to the processor 1402. The computer 1400 may also include a floppy disc drive 1414 and a compact disc (CD) drive 1415 coupled to the processor 1402. In a notebook configuration, the computer housing includes the touchpad 1417, the keyboard 1418, and the display 1419 all coupled to the processor 1402. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-12) may also be implemented in fixed computing systems, such as any of a variety of commercially available servers. An example server 1500 is illustrated in FIG. 15. Such a server 1500 typically includes one or more multicore processor assemblies 1501 coupled to volatile memory 1502 and a large capacity nonvolatile memory, such as a disk drive 1504. As illustrated in FIG. 15, multicore processor assemblies 1501 may be added to the server 1500 by inserting them into the racks of the assembly. The server 1500 may also include a floppy disc drive, compact disc (CD), or digital versatile disc (DVD) disc drive 1506 coupled to the processor 1501. The server 1500 may also include network access ports 1503 coupled to the multicore processor assemblies 1501 for establishing network interface connections with a network 1505, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

Implementation examples are described in the following paragraphs. While some of the following implementation examples are described in terms of example methods, further example implementations may include: the example methods discussed in the following paragraphs implemented by a computing device comprising a processor configured with processor-executable instructions to perform operations of the example methods; the example methods discussed in the following paragraphs implemented by a computing device including means for performing functions of the example methods; and the example methods discussed in the following paragraphs implemented as a non-transitory processor-readable storage medium having stored thereon processor-executable instructions configured to cause a processor of a computing device to perform the operations of the example methods.

Example 1. A method performed in a computing device for generating executable code to provide control flow integrity, including identifying indirect function call candidate functions from a source code by a compiler, replacing, by the compiler, an indirect function call from the source code with a call to a wrapper function, and collocating the indirect function call candidate functions in at least one range of addresses of memory by a linker, in which the wrapper function is configured to determine whether an address to be passed to the indirect function call is within the at least one range of addresses of memory.

Example 2. The method of example 1, in which collocating the indirect function call candidate functions in the at least one range of addresses of memory includes collocating a first set of functions of the indirect function call candidate functions in a first range of addresses of a first memory, and collocating a second set of functions of the indirect function call candidate functions in a second range of addresses of a second memory, in which the wrapper function is configured such that determining whether the address to be passed to the indirect function call is within the at least one range of addresses of memory includes determining whether the address to be passed to the indirect function call is within the at least one of the first range of addresses of the first memory and the second range of addresses of the second memory.

Example 3. The method of either of example 1 or 2, further including calculating a first representation of an address of each of the indirect function call candidate functions, and populating a bloom filter using the representation of the address of each of the indirect function call candidate functions, in which the wrapper function further includes calculating a representation the address to be passed to the indirect function call, and determining whether the address to be passed to the indirect function call is an address of an indirect function call candidate function by comparing the representation the address to be passed to the indirect function call to the bloom filter.

Example 4. The method of either of example 1 or 2, further including setting a hardware bit associated with an address of a first instruction of each of the indirect function call candidate functions, in which the wrapper function may further include to determine whether the hardware bit is associated with the address to be passed to the indirect function call.

Example 5. The method of either of example 1 or 2, further including setting a hardware bit associated with an address of a first instruction of each of the indirect function call candidate functions and determining whether the hardware bit is associated with the address to be passed to the indirect function call by a processor hardware instruction.

Example 6. The method of any of examples 1-5, further including identifying an aspect of the indirect function call candidate function from the source code, in which collocating the indirect function call candidate functions in at least one range of addresses of memory includes collocating a first set of functions of the indirect function call candidate functions having a first aspect in a first range of addresses of memory, and collocating a second set of functions of the indirect function call candidate functions having a second aspect in a second range of addresses of memory.

Example 7. The method of any of examples 1-6, further including generating information of boundaries of the at least one range of addresses of memory, in which the wrapper function is configured to use the information of the boundaries of the at least one range of addresses of memory to determine whether the address to be passed to the indirect function call is within the at least one range of addresses of memory.

Example 8. The method of any of examples 1-7, further including passing the indirect function call candidate functions by the compiler to the linker.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer-readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disc, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method performed in a computing device for generating executable code to provide control flow integrity, comprising:
identifying indirect function call candidate functions from a source code by a compiler;
replacing, by the compiler, an indirect function call from the source code with a call to a wrapper function; and
collocating the indirect function call candidate functions in at least one range of addresses of memory by a linker,
wherein the wrapper function is configured to determine whether an address to be passed to the indirect function call is within the at least one range of addresses of memory.

2. The method of claim 1, wherein collocating the indirect function call candidate functions in the at least one range of addresses of memory comprises:
collocating a first set of functions of the indirect function call candidate functions in a first range of addresses of a first memory; and
collocating a second set of functions of the indirect function call candidate functions in a second range of addresses of a second memory,
wherein the wrapper function is configured such that determining whether the address to be passed to the indirect function call is within the at least one range of addresses of memory comprises determining whether the address to be passed to the indirect function call is within the at least one of the first range of addresses of the first memory and the second range of addresses of the second memory.

3. The method of claim 1, further comprising:
calculating a first representation of an address of each of the indirect function call candidate functions; and
populating a bloom filter using the representation of the address of each of the indirect function call candidate functions,
wherein the wrapper function is further configured to:
calculate a representation of the address to be passed to the indirect function call; and
determine whether the address to be passed to the indirect function call is an address of an indirect function call candidate function by comparing the representation of the address to be passed to the indirect function call to the bloom filter.

4. The method of claim 1, further comprising setting a hardware bit associated with an address of a first instruction of each of the indirect function call candidate functions,
wherein the wrapper function is further configured to determine whether the hardware bit is associated with the address to be passed to the indirect function call.

5. The method of claim 1, further comprising:
setting a hardware bit associated with an address of a first instruction of each of the indirect function call candidate functions; and
determining whether the hardware bit is associated with the address to be passed to the indirect function call by a processor hardware instruction.

6. The method of claim 1, further comprising identifying an aspect of the indirect function call candidate function from the source code,
wherein collocating the indirect function call candidate functions in at least one range of addresses of memory comprises:
collocating a first set of functions of the indirect function call candidate functions having a first aspect in a first range of addresses of memory; and
collocating a second set of functions of the indirect function call candidate functions having a second aspect in a second range of addresses of memory.

7. The method of claim 1, further comprising generating information of boundaries of the at least one range of addresses of memory,
wherein the wrapper function is configured to use the information of the boundaries of the at least one range of addresses of memory to determine whether the address to be passed to the indirect function call is within the at least one range of addresses of memory.

8. The method of claim 1, further comprising passing the indirect function call candidate functions by the compiler to the linker.

9. A computing device, comprising a processing device configured with processing device-executable instructions to:
identify indirect function call candidate functions from a source code by a compiler;
replace, by the compiler, an indirect function call from the source code with a call to a wrapper function; and
collocate the indirect function call candidate functions in at least one range of addresses of memory by a linker,
wherein the wrapper function is configured to determine whether an address to be passed to the indirect function call is within the at least one range of addresses of memory.

10. The computing device of claim 9, wherein the processing device is configured with processing device-executable instructions to collocate the indirect function call candidate functions in the at least one range of addresses of memory by:
collocating a first set of functions of the indirect function call candidate functions in a first range of addresses of a first memory; and
collocating a second set of functions of the indirect function call candidate functions in a second range of addresses of a second memory,
wherein the wrapper function is configured to determine whether the address to be passed to the indirect function call is within the at least one range of addresses of memory by determining whether the address to be passed to the indirect function call is within the at least one of the first range of addresses of the first memory and the second range of addresses of the second memory.

11. The computing device of claim 9, wherein the processing device is further configured with processing device-executable instructions to:
calculate a first representation of an address of each of the indirect function call candidate functions; and
populate a bloom filter using the representation of the address of each of the indirect function call candidate functions,
wherein the wrapper function is further configured to:
calculate a representation of the address to be passed to the indirect function call; and
determine whether the address to be passed to the indirect function call is an address of an indirect function call candidate function by comparing the representation of the address to be passed to the indirect function call to the bloom filter.

12. The computing device of claim 9, wherein the processing device is further configured with processing device-executable instructions to set a hardware bit associated with an address of a first instruction of each of the indirect function call candidate functions,
wherein the wrapper function is further configured to determine whether the hardware bit is associated with the address to be passed to the indirect function call.

13. The computing device of claim 9, wherein:
the processing device is further configured to set a hardware bit associated with an address of a first instruction of each of the indirect function call candidate functions; and
the processing device comprises a hardware instruction to determine whether the hardware bit is associated with the address to be passed to the indirect function call.

14. The computing device of claim 9, wherein the processing device is further configured with processing device-executable instructions to:
identify an aspect of the indirect function call candidate function from the source code; and
collocate the indirect function call candidate functions in at least one range of addresses of memory by:
collocating a first set of functions of the indirect function call candidate functions having a first aspect in a first range of addresses of memory; and
collocating a second set of functions of the indirect function call candidate functions having a second aspect in a second range of addresses of memory.

15. The computing device of claim 9, wherein the processing device is further configured with processing device-executable instructions to generate information of boundaries of the at least one range of addresses of memory,
wherein the wrapper function is configured to use the information of the boundaries of the at least one range of addresses of memory to determine whether the address to be passed to the indirect function call is within the at least one range of addresses of memory.

16. The computing device of claim 9, wherein the processing device is further configured with device-executable instructions to pass the indirect function call candidate functions by the compiler to the linker.

17. A non-transitory, processor-readable medium having stored thereon processor-executable instructions configured to cause a processor of a computing device to perform operations comprising:
identifying indirect function call candidate functions from a source code by a compiler;
replacing, by the compiler, an indirect function call from the source code with a call to a wrapper function; and
collocating the indirect function call candidate functions in at least one range of addresses of memory by a linker,
wherein the wrapper function is configured to determine whether an address to be passed to the indirect function call is within the at least one range of addresses of memory.

18. The non-transitory, processor-readable medium of claim 17, wherein the stored processor-executable instructions are configured to cause the processor of the computing device to perform operations such that collocating the indirect function call candidate functions in the at least one range of addresses of memory comprises:
collocating a first set of functions of the indirect function call candidate functions in a first range of addresses of a first memory; and
collocating a second set of functions of the indirect function call candidate functions in a second range of addresses of a second memory,
wherein the wrapper function is configured to determine whether the address to be passed to the indirect function call is within the at least one range of addresses of memory by determining whether the address to be passed to the indirect function call is within the at least one of the first range of addresses of the first memory and the second range of addresses of the second memory.

19. The non-transitory, processor-readable medium of claim 17, wherein the stored processor-executable instructions are configured to cause the processor of the computing device to perform operations further comprising:
calculating a first representation of an address of each of the indirect function call candidate functions; and
populating a bloom filter using the representation of the address of each of the indirect function call candidate functions,
wherein the wrapper function is further configured to:
calculate a representation of the address to be passed to the indirect function call; and
determine whether the address to be passed to the indirect function call is an address of an indirect function call candidate function by comparing the representation of the address to be passed to the indirect function call to the bloom filter.

20. The non-transitory, processor-readable medium of claim 17, wherein the stored processor-executable instructions are configured to cause the processor of the computing device to perform operations further comprising setting a hardware bit associated with an address of a first instruction of each of the indirect function call candidate functions,
wherein the wrapper function is further configured to determine whether the hardware bit is associated with the address to be passed to the indirect function call.

21. The non-transitory, processor-readable medium of claim 17, wherein the stored processor-executable instructions are configured to cause the processor of the computing device to perform operations further comprising setting a hardware bit associated with an address of a first instruction of each of the indirect function call candidate functions; and
wherein the processor includes a hardware instruction to perform operations comprising determining whether the hardware bit is associated with the address to be passed to the indirect function call.

22. The non-transitory, processor-readable medium of claim 17, wherein the stored processor-executable instructions are configured to cause the processor of the computing device to perform operations further comprising identifying an aspect of the indirect function call candidate function from the source code, and
wherein the stored processor-executable instructions are configured to cause the processor of the computing device to perform operations such that collocating the indirect function call candidate functions in at least one range of addresses of memory comprises:
collocating a first set of functions of the indirect function call candidate functions having a first aspect in a first range of addresses of memory; and
collocating a second set of functions of the indirect function call candidate functions having a second aspect in a second range of addresses of memory.

23. The non-transitory, processor-readable medium of claim 17, wherein:
the stored processor-executable instructions are configured to cause the processor of the computing device to perform operations further comprising generating information of boundaries of the at least one range of addresses of memory; and
the wrapper function is configured to use the information of the boundaries of the at least one range of addresses of memory to determine whether the address to be passed to the indirect function call is within the at least one range of addresses of memory.

24. The non-transitory, processor-readable medium of claim 17, wherein the stored processor-executable instructions are configured to cause the processor of the computing device to perform operations further comprising passing the indirect function call candidate functions by the compiler to the linker.
